(19) United States
(12) Patent Application Publication
(10) Pub. No.: US 2009/0029899 A1
(43) Pub. Date: Jan. 29, 2009

(54) Fabric softening composition

(75) Inventors: David Stephen Grainger, Bebington (GB); Christopher John Roberts, Bebington (GB); David William Thornthwaite, Bebington (GB); Shaun Charles Walsh, Bebington (GB)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc. d/b/a Unilever

(21) Appl. No.: 12/220,360

(22) Filed: Jul. 24, 2008

(30) Foreign Application Priority Data
Jul. 27, 2007 (GB) 0714589.9

(51) Int. Cl. C11D 3/00

(52) U.S. Cl. 510/516

(57) ABSTRACT

A fabric softening composition having a pH of from 2 to 3 and comprising
a) from 1.5 to 50% by weight of a cationic fabric softening compound having two or more alkyl or alkenyl chains each having an average chain length equal to, or greater than C₈ each connected to a nitrogen atom via at least one ester linkage, the iodine value of the parent fatty acyl compound or acid from which the alkyl or alkenyl chains are derived being from 0 to 20, preferably 0 to 5, more preferably 0 to 2, most preferably 0, the softening compound being free from acid amide links,
b) at least 0.15% by weight of perfume, and
c) a plasticizer which is liquid at ambient temperature, in an effective amount such that the fabric conditioning composition has a major phase transition peak of not more than 52° C. measured by differential scanning calorimetry (DSC).

### TECHNICAL FIELD

This invention relates to fabric softener compositions comprising a fabric softener compound which is an ester-linked quaternary ammonium compound (ester quat).

### BACKGROUND OF THE INVENTION

Liquid fabric conditioning compositions which soften fabrics in the rinse cycle are known.

Such compositions comprise less than 7.5% by weight of softening active, in which case the composition is defined as “dilute”, from 7.5% to about 30% by weight of active in which case the compositions are defined as “concentrated” or more than about 30% by weight of active, in which case the composition is defined as “super-concentrated”.

Concentrated and super-concentrated compositions are desirable since these require less packaging and are therefore environmentally more compatible than dilute or semi-dilute compositions.

A problem frequently associated with fabric conditioning compositions, as defined above, is that the product is not stable upon storage, especially when stored at high temperatures. Instability can manifest itself as a thickening of the product upon storage, even to the point that the product is no longer pourable.

The problem of thickening upon storage is particularly apparent in concentrated and super concentrated fabric softening compositions comprising an ester-linked quaternary ammonium fabric softening material having one or more fully saturated alkyl chains.

However, it is desirable to use ester-linked compounds due to their inherent biodegradability and to use substantially fully saturated quaternary ammonium fabric softening compounds due to their excellent softening capabilities and because they are more stable to oxidative degradation (which can lead to malodour generation) than partially saturated or fully unsaturated quaternary ammonium softening compounds.

Of the types of ester-linked quaternary ammonium materials known, it is desirable to use those based on triethanolamine (TEAQ) which comprise at least some mono-ester linked component and at least some tri-ester linked component as well as the di-ester component.

The biodegradable ester quats are prone to hydrolysis over any appreciable duration at high temperatures. The ester link between the quaternary head group and the alkyl chain is cleaved via either acid or base catalysed hydrolysis liberating free fatty acid (FFA) into the system. As hydrolysis continues to occur the level of FFA continues to rise until such point that the system becomes colloidally unstable. At this point the products typically become consumer unacceptable due to thickening, separation, gelation or combinations thereof. There is therefore a need to retard hydrolysis as much as possible.

EP302567 has identified that residual amine catalyses hydrolysis in ester quats and that this can be alleviated to some degree by converting the residual amine to its protonated form via addition of certain acids (such as HCl, H₂SO₄). Whilst this may work with unsaturated ester quats, this approach is much more limited in fully hardened systems which typically form semi-crystalline L(Beta) phase bi-layer structures. It is believed this is largely due to the physical properties of fully hardened systems whereby the insoluble and largely solid residual amine is incompatible with the water soluble acids. This is especially true for the case of triethanolamine based ester quats as the residual amine in this case is predominantly tri-ester amine (this is due to steric hindrance around the nitrogen during the quaternisation stage of the ester quat manufacture).

It is advantageous to use fully hardened actives with no unsaturated components in the formulation to avoid the risk of malodour. Unsaturated actives can oxidise either during storage before use by the consumer (to give an oily or fatty smelling product) or during use (to give fatty or oily odours on the consumers garments). Metal ion sequestrants can be added to the formulations to prevent the onset of oxidation in the bottle on storage as disclosed in EP856045. However, once the active is present on the fabric, the combination of the large surface area, exposure to UV light and limitless oxygen means that oxidation is inevitable. This will ultimately lead to consumer perceivable malodours on clothes and garments.

There is a need to be able to make robust formulations across all concentration ranges and that are capable of delivering a wide range of perfume types and levels. Typically dilute products are relatively straightforward products to make due to the relatively low level of active that they contain. Concentrate products are usually much more problematic and as such they require extra formulation aids to make them stable and consumer acceptable. These are typically either electrolytes or surfactants (e.g. ethoxylated non-ionics). It is also the case that concentrate products made from unsaturated actives are easier to make than analogous products based on fully hardened actives. However, whilst these are easier to make, they are undesirable for the reasons of malodour. Similarly, whilst it is possible to make concentrate products based on fully hardened actives using surfactant formulation aids such as alcohol ethoxylate non-ionics; these products are limited in terms of their ability to tolerate very high perfume levels. Without wishing to be bound by theory, it is believed that certain components interact with the non-ionic formulation aids, rendering them inactive (see for example Tokuoka et al, J. Coll. and Int. Sci, Vol. 152 (No. 2) p 402-409 (1992)). When this occurs the products tend to thicken or gel (even in the absence of hydrolysis) rendering them consumer unacceptable.

Therefore, there is a need to be able to make hydrolytically stable products, across both the concentrate and dilute active ranges which are based on either fully hardened or substantially hardened actives and which are robust to the full range of perfume types and levels.

Fabric softening compositions comprising hardened ester quats based on triethanolamine are known and disclosed, for example in WO2003/22967, WO2003/22969, WO2003/22970, WO2003/22971, WO2003/22972 and WO2003/22973. The compositions often contain a fatty complexing agent such as fatty alcohols and fatty acids e.g. a linear C₁₆-C₁₈ alcohol, that complexes with the monoester quat.

EP980352 discloses using acids to adjust the pH to between 1.5 and 7 (preferably 2-4.5) in combination with ester quats made with di-carboxylic acids (i.e. that form oligomeric ester quats). It does not disclose why this is desirable. There are some examples based on hardened tallow materials.

U.S. Pat. No. 5,476,597 discloses aqueous softener compositions comprising at least one quaternary ammonium salt which has one ester link and one acid amine link. It discloses it is preferable to adjust pH to between 2 to 6 and to improve softening or storage stability it may be advisable to include linear or branched, saturated or unsaturated fatty acids. It further mentions that non-ionic surfactants or hydrotropes can further improve stability. However, all of these recommendations are made in the context that the primary softening active is the softening active containing both an ester and an acid amide link. This is further endorsed by the examples which show that only the examples containing this ester/acid amide component (component A) are stable at 50° C. It clearly teaches that quats based on ester/acid amides are more stable than equivalent di-ester materials.

EP850291 discloses compositions in the absence of oily perfumes based on mixtures of an amido amine and an ester quaternary. It teaches that stability can be enhanced by the inclusion of at least one fatty ester of a fatty alcohol or fatty acid. It also discloses the need to add a strong acid (such as HCl). However, in the examples no hard TEAQ are included in their examples (only Tetranyl AT-75 which is an unsaturated “soft” TEAQ). It discloses that the fatty ester functions as an emulsion or dispersion stabilizer and that it has a similar function to an oily perfume. It specifically mention that it helps the colloidal stability by permitting the preparation of stable unperfumed dispersions having pourable viscosities (i.e. their impact is from time zero and not to counter the impact of hydrolysis over time). Furthermore, whilst the addition of the acid will convert any ester amine to its protonated form, its primary function is to convey the neutral acid amine to its protonated form to facilitate the dispersion of the actives into water (i.e. by making them more water soluble).

WO94/04643 discloses TEA quats (1-20%) in combination with mineral or organic acids (1-25%). It teaches that the reason for including the acid is two-fold. Firstly to act as a builder by removing the insoluble calcium salts from the water and second to remove any mineral encrustations previously formed on the fabric. In terms of examples, the only TEAQ exemplified is Stepantex VHR90 which is a soft TEAQ.

U.S. Pat. No. 4,844,823 discloses the use of compositions based on dialkyl quaternaries and fatty alcohols. It also mentions the use of acids as a means to convert any ethoxylated amine (an optional ingredient listed as an emulsifier) into its protonated form.

U.S. Pat. No. 4,789,491 discloses branched analogues of TEAQ and DEEDMAC claiming they provide both a biodegradable softener active but also one which has superior hydrolytic stability. It is disclosed that i) amines catalyse hydrolysis and hence it is important to minimise their level in the raw material and ii) even if minor levels are present, it is important to convert these their protonated form via strong acids such as HCl, H₂SO₄, HNO₃.

WO9325648 discloses di-ester quaternary based compositions but wherein one of the ester links must be a reverse ester. It also discloses the same information as U.S. Pat. No. 4,789,491 regarding the impact of amines and the addition of acid to neutralise them.

EP309052 also discloses the same information relating to amines and their impact on chemical degradation of the ester quat. It is also claimed that the use of a C₈-C18 fatty alcohol non-ionic surfactant with 1-10EO functions on it also improves hydrolytic stability.

WO9323510 discloses concentrate DEEDMAC formulations with dispersability modifiers (either single chain cations or certain alcohol ethoxylates. It is disclosed that it is advantageous to adjust pH to between 2 and 4.

U.S. Pat. No. 5,066,414 teaches a very similar approach to EP309052, i.e. that pH control is essential to convert amines to their protonated salts and that linear alcohol ethoxylates with 1-10EO functions also help hydrolysis.

WO2002/0782745 discloses compositions containing i) di-and tri-ester based cationic surfactant ii) a surfactant scavenger and iii) a suds suppression system whereby the suds suppression value needs to be >90%. The di- and tri esters surfactant can be either TEAQ or DEEDMAC and it is also preferred if the surfactant scavenger is the mono-alkyl version of the cationic.

The present invention provides fabric softener compositions comprising hardened or substantially hardened ester quats with good storage stability.

### SUMMARY OF THE INVENTION

According to the present invention there is provided a fabric softening composition having a pH of from 2 to 3 and comprising
a) from 1.5 to 50% by weight of a cationic fabric softening compound having two or more alkyl or alkenyl chains each having an average chain length equal to, or greater than C₈ each connected to a nitrogen atom via at least one ester linkage, the iodine value of the parent fatty acyl compound or acid from which the alkyl or alkenyl chains are derived being from 0 to 20, preferably 0 to 5, more preferably 0 to 2, most preferably 0, the softening compound being free from acid amide links,
b) at least 0.15% by weight of perfume, and
c) a plasticizer which is liquid at ambient temperature, in an effective amount such that the fabric conditioning composition has a major phase transition peak of not more than 52° C. measured by differential scanning calorimetry (DSC).

The compositions may contain other optional ingredients e.g. fatty complexing agents, thickening polymers, dyes, preservatives, anti-foams, electrolytes, etc.

By including the plasticizer in the fabric softening compositions and adjusting the pH in the range 2 to 3, the major phase transition peak of the composition may be suppressed below 52° C. In the absence of the plasticizer the transition peak would be significantly higher. The resulting compositions have advantageous properties.

Firstly, the compositions of the invention are free or substantially free of unsaturated active and hence do not suffer from oxidation or malodour.

Secondly, the physical state of the bi-layer is changed from a predominantly semi-crystalline L(beta) phases to a predominantly mobile L(alpha) phase. It is believed this facilitates the protonation of the residual amine by softening or solubilising the insoluble amine. Once protonated, the residual amine no longer acts as a catalyst for hydrolysis and hence the long term stability of the compositions is much improved.

Thirdly, by creating a more mobile L(alpha) based microstructure it is possible to use electrolytes to control the viscosity of concentrate products (as opposed to ethoxylated non-ionic surfactants). This removes many of the restrictions on perfume components and perfume levels that have previously been present with compositions containing hard actives.

### Fabric Softening Compounds

The preferred cationic fabric softening compound(s) are those having two or more alkyl or alkenyl chains each having an average chain length equal to, or greater than C₈, especially C₁₂₋₂₈ alkyl or alkenyl chains connected to a nitrogen atom, via two or more ester linkages. The cationic fabric softening compounds are ester-linked quaternary ammonium fabric softening compounds. The compounds are free from acid amine links.

Especially suitable compounds have two or more alkyl or alkenyl chains each having an average chain length equal to, or greater than C₁₄, more preferably, equal to or greater C₁₆.

It is advantageous for environmental reasons that the ester-softening compound is biologically degradable. It is preferred if the alkyl or alkenyl chains of the ester-softening compound are predominantly linear.

A first group of fabric softening compounds suitable for use in the present invention is represented by formula (I):

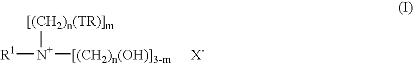

wherein each R is independently selected from a C₅₋₃₅ alkyl or alkenyl group; R¹ represents a C₁₋₄ alkyl, C₂₋₄ alkenyl or a C₁₋₄ hydroxyalkyl group; T is generally O—CO. (i.e. an ester group bound to R via its carbon atom), but may alternatively be CO-O (i.e. an ester group bound to R via its oxygen atom); n is a number selected from 1 to 4; m is a number selected from 1, 2, or 3; and X⁻ is an anionic counter-ion, such as a halide or alkyl sulphate, e.g. chloride or methylsulphate. Di-ester variants of formula I (i.e. m=2) are preferred and typically have mono- and tri-ester analogues associated with them. Such materials are particularly suitable for use in the present invention.

Especially preferred agents are di-esters of triethanolammonium methylsulphate, otherwise referred to as “TEA ester quats”. Commercial examples include Tetranyl AHT-1, ex Kao, (di-[hardened tallow ester] of triethanolammonium methylsulphate).

A second group of fabric softening compounds suitable for use in the invention is represented by formula (II):

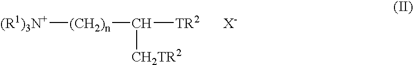

wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups; and wherein n, T, and X⁻ are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding mono-ester.

A third group of QACs suitable for use in the invention is represented by formula (III):

(R¹)₂—N⁺—[(CH₂)ₙ—T—R²]₂X⁻ (III)

wherein each R¹ group is independently selected from C₁₋₄ alkyl, or C₂₋₄ alkenyl groups; and wherein each R² group is independently selected from C₈₋₂₈ alkyl or alkenyl groups; and n, T, and X⁻ are as defined above. Preferred materials of this third group include bis(2-tallowoyloxyethyl)dimethyl ammonium chloride and hardened versions thereof.
Iodine Value of the Parent Fatty Acyl group or Acid

The iodine value of the parent fatty acyl compound or acid from which the quaternary ammonium fabric softening material is formed is from 0 to 20, preferably from 0 to 5, more preferably from 0 to 2. Most preferably the iodine value of the parent fatty acid or acyl group from which the quaternary ammonium fabric softening material is formed is from 0 to 1, especially 0. That is, it is preferred that the alkyl or alkenyl chains are substantially fully saturated.

If there is any unsaturated quaternary ammonium fabric softening material present in the composition, the iodine value, referred to above, represents the mean iodine value of the parent fatty acyl compounds or fatty acids of all of the quaternary ammonium materials present.

In the context of the present invention, iodine value of the parent fatty acyl compound or acid from which the fabric softening material formed, is defined as the number of grams of iodine which react with 100 grams of the compound.

In the context of the present invention, the method for calculating the iodine value of a parent fatty acyl compound/acid comprises dissolving a prescribed amount (from 0.1-3 g) into about 15 ml chloroform. The dissolved parent fatty acyl compound/fatty acid is then reacted with 25 ml of iodine monochloride in acetic acid solution (0.1M). To this, 20 ml of 10% potassium iodide solution and about 150 ml deionised water is added. After addition of the halogen has taken place, the excess of iodine monochloride is determined by titration with sodium thiosulphate solution (0.1M) in the presence of a blue starch indicator powder. At the same time a blank is determined with the same quantity of reagents and under the same conditions. The difference between the volume of sodium thiosulphate used in the blank and that used in the reaction with the parent fatty acyl compound or fatty acid enables the iodine value to be calculated.

The quaternary ammonium fabric softening material is present in an amount from 1.5 to 50% by weight of quaternary ammonium material (active ingredient) based on the total weight of the composition, generally 2 to 40% by weight, e.g. 5 to 25% by weight.

Broadly speaking, the conditioning active compositions of the present invention, also known as esterquats, are made by combining a fatty acid source and an alkanolamine, typically at a starting temperature at which the fatty acid source is molten, optionally adding a catalyst, then heating the reaction mixture while drawing vacuum until the desired endpoint(s), such as acid value and final alkalinity value, are reached. The resulting esteramine intermediate is then quaternised using an alkylating agent, yielding an esterquat product. The esterquat product may be a mixture of quaternised monoester, diester, and triester components and optionally some amount of one or more reactants, intermediates, and byproducts, including but not limited to free amine and free fatty acid or parent fatty acyl compounds.

### Plasticizers

The plasticizer is liquid at room temperature and is selected to suppress the major phase transition peak of the composition to a temperature below 52° C. Suitable. plasticizers include unsaturated and/or branched alcohols and fatty acids. Unsaturated compounds may cause odour problems and are not preferred, particularly suitable branched alcohols and acids containing from 12 to 18 carbon atoms.

Other suitable plasticizers include long chain fatty esters e.g. R¹⁰COOR¹² in which R¹⁰ is C₁₂-C₂₄ and R¹² is C₁-C₆, preferably with branching on R¹⁰ and/or R¹².

Other suitable plasticizers include principal solvents, as disclosed in EP0842250. Principal solvents have a ClogP of from 0.15 to 0.64, preferably 0.40 to 0.60 and preferably have an asymmetric structure. Diol principal solvents are preferred including cyclic diols e.g. compound containing cyclobutanediol, cyclopentanediol, and cyclohexanediol structures.

Other suitable plasticizers include hydrotropes, such as D(polyoxypropylene) (polyoxyethylene) (polyoxypropylene) block copolymers. Such materials are commercially available under the trade name Pluronic.

The plasticizer is present in an effective amount such that the resulting composition has a major phase transition peak below 52° C. Generally the composition will comprise at least 0.25%, preferably at least 0.5% by weight of plasticizer. The weight ratio of fabric softening compounds to plasticizer is generally in the range 3:1 to 50:1 preferably 5:1 to 25:1.

Preferably the composition has a major phase transition temperature below 50° C., more preferably below 45° C.

pH

The pH of the compositions is adjusted to a pH range of 2.0 to 3.0. Any suitable acid may be used e.g. HCl.

### Perfume

The compositions comprise at least 0.15% by weight, generally from 0.15 to 3% by weight of perfume.

The invention will be described with reference to the following Examples in which Examples identified by numerals are comparative Examples and Examples identified by letters are in accordance with the invention.

### EXAMPLES 1 TO 4

The following four examples illustrate the benefits and limitations of simply reducing amine level in the TEAQ raw materials (this is outside the scope of the invention and demonstrates the limitations of the prior art).

The fabric softener compounds (HT-TEAQ) were made by a standard procedure. Approx 2 mols of fully hardened tallow fatty acid are reacted with 1 mole of triethanolamine during the esterification stage. The samples were then converted to the TEA quaternary via reaction with dimethyl sulphate. The level of residual amine in each example was sequentially reduced by increasing the amount of DMS used in the quaternisation stage of each raw material. This is indicated by the reduction in the amine level (expressed as mmol amine per gram of raw material). The final stage was to add IPA solvent to each raw material (at 15%) to enable the material to be handled at reasonable operating temperatures (i.e. less than 70° C.).

The residual amine levels of the four raw materials were 0.096, 0.065, 0.035 and 0.003 mmol amine per gram of raw material. This was achieved by increasing the DMS addition during the final quaternisation stage. An amine level of 0.003 mmol represents virtually complete quaternisation (i.e. 1:1 molar ratio between the number moles of TEA and the number of moles of DMS).

These four raw materials were then used to make dilute fabric conditioner compositions according to a standard composition and standard process (all at 3.5 kg scale).

5.54% HT-TEAQ (selected from the above)

0.39% Hardened C16-C18 Fatty alcohol (Tradename Stenol 16-181)

0.34% Perfume

Minors: Dye, preservative, antifoam

Demin Water to 100%

The formulations were prepared as follows. The water was preheated to 70° C. and the minors were added with stirring. The HT-TEAQ and the fatty alcohol were then co-melted together before being slowly added to the water mixture with stirring. The mixture was mixed at this temperature for a further 10 minutes before being cooled (via jacketed vessel). The perfume was added to the vessel once the temperature had reached 40° C. After this, the mixture was cooled to 30° C. at which point the composition was discharged. All four formulations were then put on store at 45° C. to monitor both viscosity stability and hydrolytic stability.

Hydrolytic stability was measured by evaluating the free fatty acid level of the total solids after 8 weeks at 45° C. using HPLC. Higher fatty acid levels indicate higher degrees of hydrolysis as the fatty acid is the direct product of ester bond cleavage. The fatty acid levels after 8 weeks storage at 45° C. are shown in the table below.

| | TEAQ Raw Material | FFA level after |
|---|---|---|
| | Amine level | 8 weeks at 45° C. |
| Example | (mmol/g) (PAT) | (wt % age) |
| 1 | 0.096 | 35.75% |
| 2 | 0.065 | 34.33% |
| 3 | 0.035 | 27.78% |
| 4 | 0.003 | 23.48% |

### Viscostability

Example 1 unacceptable thickening at 6 weeks at 45° C.

Example 2 unacceptable thickening at 8 weeks at 45° C.

Example 3 unacceptable thickening at 8 weeks at 45° C.

Example 4 unacceptable thickening at 10 weeks at 45° C.

These results demonstrate three points. First, reducing amine alone has an impact on hydrolysis in that the degree of hydrolysis is reduced. Second, whilst the reduction in amine level is almost to the point of zero residual amine, the reduction in degree of hydrolysis is not linearly related. In fact it suggests that even a small amount of amine is still capable of catalysing hydrolysis. Lastly, whilst a reduction from ˜36% FFA to ˜23% represents a significant reduction, it only leads to an extension of about 2 weeks at 45° C. in terms of viscostability.

Furthermore, it is worth noting that the reduction of residual amine to less than about 0.035 mmol/g is extremely difficult. When 1:1 molar ratios of DMS are used (ratio no. mols TEA to DMS), side reactions begin to occur other than the intended quaternisation leading to impurities in the raw material. Hence the practical limit of this route in terms of product stability and hydrolysis is approx 28% FFA and 6-8 weeks storage at 45° C.

### EXAMPLES 5 TO 8

The following examples indicate the further benefit that can be achieved if strong mineral acids (e.g. HCl) are combined with HTTEAQs materials with intermediate residual amine levels (i.e. materials that are feasible from a manufacturing perspective). This also falls within the scope of what is known in the prior art and demonstrates the limitations of the approach.

In this case, only one HTEAQ raw material is used. It differs from the first group of samples in that the initial triethanolamine: fatty acid ratio was approximately 1:1.85. The reason for this is that when increased levels of DMS are used (to give lower amine levels), higher levels of tri-ester quaternary are produced as a consequence. [This is because the tri-ester is the most difficult amine to convert and as such is the predominant species in the residual amine mixture. Therefore when extra DMS is used, there is only tri-esteramine left to react with it—hence the proportion of trimester quaternary increases]. Therefore, in order to maintain the mono-, di- and tri-ester ratio balance of the samples in the first group of experiments, it was necessary to alter the starting ratios of the TEA:FA to compensate for this (to the lower 1:1.85). The residual amine level of the resultant quaternary is 0.041 mmol/g.

The general formulation and manufacturing process was the same as for Examples 1 to 4 except that 1 Molar HCl is added to the final mixture at room temperature until the desired pH was achieved.

The fatty acid levels after 8 weeks storage at 45° C. are shown in the table below.

| | | FFA level after |
|---|---|---|
| | | 8 wks at 45° C. |
| Example | pH of product | (wt % age) |
| 5 | 2.5 | 22.79 |
| 6 | 2.6 | 23.63 |
| 7 | 2.7 | 27.87 |
| 8 | 2.8 | 29.24 |

### Viscostability

All Examples had acceptable viscosity at 6 weeks but unacceptable thickening by 8 weeks with Examples 7 and 8 thickening before Examples 5 and 6.

The DSC data for the formulation is shown in the following Table.

| | | | | Temperature of the |
|---|---|---|---|---|
| | Plasticizer | Ratio | | Principle DSC |
| Example | (P) | HT-TEAQ:P | pH | transition peak (° C.) |
| 5 | Stenol 16-18L | 12:1 | 2.5 | 60 |
| 6 | Stenol 16-18L | 12:1 | 2.6 | 59.3 |
| 7 | Stenol 16-18L | 12:1 | 2.7 | 58.7 |

Again, this demonstrates the benefits and limitations of using lower amine and pH reduction in combination with hard TEAQ and linear fatty co-actives conventional co-actives. Hydrolysis reduction is possible but in general the samples still remain stable for only 8 weeks at 45° C. before gelling.

### EXAMPLES 9 AND A TO E

The following examples of the invention are intended to demonstrate the advantage obtained when the pH reduction is combined with the plasticizing co-actives. In these examples the basic HTTEAQ raw material of the invention is the same as for Examples 5 to 8 (i.e. based on the 1:1.85 TEA:fatty acid starting ratio and with the amine level of 0.041 mmol/g). The basic formulations are detailed in the following Table—in this case the plasticizing co-active is oleyl alcohol.

| | Example 9 | Example A | Example B | Example C | Example D | Example E |
|---|---|---|---|---|---|---|
| HTTEAQ | 5.53 | 5.53 | 5.53 | 5.53 | 5.53 | 5.53 |
| Oleyl | 0.39 | 0.39 | 0.39 | 0.39 | 0.39 | 0.39 |
| Alcohol¹ | | | | | | |
| Perfume | 0.34 | 0.34 | 0.34 | 0.34 | 0.34 | 0.34 |
| Minors | Dye, | Dye, | Dye, | Dye, | Dye, | Dye, |
| | antifoam | antifoam | antifoam | antifoam | antifoam | antifoam |
| | preservative | preservative | preservative | preservative | preservative | preservative |
| Water | To 100% | To 100% | To 100% | To 100% | To 100% | To 100% |
| 1M HCl | Unadjusted | To give | To give | To give | To give | To give |
| | pH = 3.25 | pH = 2.7 | pH = 2.6 | pH = 2.5 | pH = 2.4 | pH = 2.2 |

¹sourced from Sigma-Aldrich (85% technical grade)

The fatty acid levels after 8 weeks storage at 45° C. are shown in the table below.

| | | FFA level after |
|---|---|---|
| | | 8 weeks at 45° C. |
| Example | pH of product | (wt % age) |
| 9 | 3.25 | 29.94 |
| A | 2.7 | 18.13 |
| B | 2.6 | 15.63 |
| C | 2.5 | 14.84 |
| D | 2.4 | 13.82 |
| E | 2.2 | 12.00 |

### Viscostability

Example 9 had acceptable viscosity at 8 weeks but had thickened unacceptably by 10 weeks

Examples A and B had acceptable viscosity at 12 weeks but had unacceptably thickened by 14 weeks

Examples C and D had acceptable viscosity at 14 weeks but had thickened unacceptably by 16 weeks

Example E had acceptable viscosity after 16 weeks

The DSc data for the formulation is shown in the following Table.

| | | | | Temperature of | Temperature |
|---|---|---|---|---|---|
| | | Ratio | | the Principle | of minor |
| | Plasticizer | HT- | | DSC transition | DSC |
| Example | (P) | TEAQ:P | pH | peak (° C.) | transitions |
| 9 | Oleyl | 12:1 | 3.25 | 50.7 and 37.6 | — |
| | alcohol | | | | |
| A | Oleyl | 12:1 | 2.7 | 51.0 | 37.1 |
| | alcohol | | | | |
| B | Oleyl | 12:1 | 2.6 | 50.8 | 36.9 |
| | alcohol | | | | |
| C | Oleyl | 12:1 | 2.5 | 50.8 | 36.8 |
| | alcohol | | | | |
| D | Oleyl | 12:1 | 2.4 | 51.4 | 37.1 |
| | alcohol | | | | |
| E | Oleyl | 12:1 | 2.2 | 51.5 | 36.8 |
| | alcohol | | | | |

### EXAMPLES 10 AND F TO J

Further examples of the invention using a different ratio of HTTEAQ to oleyl alcohol. The formulations were prepared as described above.

| | Example 10 | Example F | Example G | Example H | Example I | Example J |
|---|---|---|---|---|---|---|
| HTTEAQ | 5.14 | 5.14 | 5.14 | 5.14 | 5.14 | 5.14 |
| Oleyl | 0.72 | 0.72 | 0.72 | 0.72 | 0.72 | 0.72 |
| Alcohol | | | | | | |
| Perfume | 0.34 | 0.34 | 0.34 | 0.34 | 0.34 | 0.34 |
| Minors | Dye, | Dye, | Dye, | Dye, | Dye, | Dye, |
| | antifoam, | antifoam, | antifoam, | antifoam, | antifoam, | antifoam, |
| | preservative | preservative | preservative | preservative | preservative | preservative |
| Water | To 100% | To 100% | To 100% | To 100% | To 100% | To 100% |
| 1M HCl | Unadjusted | To give | To give | To give | To give | To give |
| | pH = 3.42 | pH = 2.7 | pH = 2.6 | pH = 2.5 | pH = 2.4 | pH = 2.2 |

The fatty acid levels after 8 weeks storage at 45° C. are shown in the table below.

| | | FFA level after |
|---|---|---|
| | | 8 weeks at 45° C. |
| Example | pH of product | (wt % age) |
| 10 | 3.42 | 25.41 |
| F | 2.7 | 11.92 |
| G | 2.6 | 11.03 |
| H | 2.5 | 11.06 |
| I | 2.4 | 11.68 |
| J | 2.2 | 12.36 |

### Viscostability

All of the Examples had acceptable viscosity after 16 weeks, the viscosity of Example 10 being higher than that of Examples F to J

The DSC data for the formulations is shown in the following Table.

| | | | | Temperature of the |
|---|---|---|---|---|
| | Plasticizer | Ratio | | Principle DSC |
| Example | (P) | HT-TEAQ:P | pH | transition peak (° C.) |
| 10 | Oleyl | 6:1 | 3.42 | 45.0 and 49.7 |
| | alcohol | | | |
| F | Oleyl | 6:1 | 2.7 | 43.4 and 49.3 |
| | alcohol | | | |
| B | Oleyl | 6:1 | 2.6 | 43.2 and 48.9 |
| | alcohol | | | |
| H | Oleyl | 6:1 | 2.5 | 44.9 and 49.9 |
| | alcohol | | | |
| I | Oleyl | 6:1 | 2.4 | 45.8 |
| | alcohol | | | |
| J | Oleyl | 6:1 | 2.2 | 48.5 |
| | alcohol | | | |

Comparing the hydrolysis figures for Examples 5, 6 and 7 and Examples A, B and C and also versus Examples F, G and H clearly show the reduced hydrolysis obtained when pH reduction is combined with the plasticizing co-actives. Furthermore the benefit is maintained at pHs as low as 2.2. This extra chemical stability is also reflected in superior viscosity stability with the sample surviving >16 weeks at 45° C. which is significantly superior to Examples 1 to 8 (which have the fully hardened C₁₆-C₁₈ fatty alcohol coactive) and Examples 9 and 10 which do not have the pH reduction.

### EXAMPLES 11 AND K TO M

Further examples with a branched alcohol co-active acting as the plasticizer (Isofol 18E ex Sasol) which is a mixture of branched chain alcohols comprising 2-hexyl and 2-octyl-dodecanol.

| | Example 11 | Example K | Example L | Example M |
|---|---|---|---|---|
| HTTEAQ | 5.53 | 5.53 | 5.53 | 5.53 |
| Isofol | 0.39 | 0.39 | 0.39 | 0.39 |
| 18E | | | | |
| Perfume | 0.34 | 0.34 | 0.34 | 0.34 |
| Minors | Dye, | Dye, | Dye, | Dye, |
| | antifoam, | antifoam, | antifoam, | antifoam, |
| | preservative | preservative | preservative | preservative |
| Water | To 100% | To 100% | To 100% | To 100% |
| 1 M HCl | Unadjusted | To give | To give | To give |
| | pH = 3.24 | pH = 2.7 | pH = 2.5 | pH = 2.2 |

The fatty acid levels after 8 weeks storage at 45° C. are shown in the table below.

| | | FFA level after |
|---|---|---|
| | | 8 weeks at 45° C. |
| Example | pH of product | (wt % age) |
| 11 | 3.24 | 24.68 |
| K | 2.7 | 11.75 |
| L | 2.5 | 10.72 |
| M | 2.2 | 12.40 |

### Viscostability

Example 11 had unacceptable viscosity at 10 weeks

Examples K to M had acceptable viscosity after 12 weeks with Example K starting to thicken

The DSc data for the formulation is shown in the following Table.

| | | | | Temperature of | Temperature |
|---|---|---|---|---|---|
| | | Ratio | | the Principle | of minor |
| | Plasticizer | HT- | | DSC transition | DSC |
| Example | (P) | TEAQ:P | pH | peak (° C.) | transitions |
| 11 | Isofol 18E | 12:1 | 3.24 | 41.8 | 51.5 |
| M | Isofol 18E | 12:1 | 2.7 | 40.7 | 51.0 |
| L | Isofol 18E | 12:1 | 2.5 | 40.7 | 51.3 |
| K | Isofol 18E | 12:1 | 2.2 | 39.7 | 51.3 |

### EXAMPLES 12 AND N TO P

Further examples of the invention using a different ratio of HTTEAQ to Isofol 18E.

| | Example 12 | Example N | Example O | Example P |
|---|---|---|---|---|
| HTTEAQ | 5.14 | 5.14 | 5.14 | 5.14 |
| Isofol | 0.72 | 0.72 | 0.72 | 0.72 |
| 18E | | | | |
| Perfume | 0.34 | 0.34 | 0.34 | 0.34 |
| Minors | Dye, | Dye, | Dye, | Dye, |
| | antifoam, | antifoam, | antifoam, | antifoam, |
| | preservative | preservative | preservative | preservative |
| Water | To 100% | To 100% | To 100% | To 100% |
| 1 M HCl | Unadjusted | To give | To give | To give |
| | pH = 3.37 | pH = 2.7 | pH = 2.5 | pH = 2.2 |

The fatty acid levels after 8 weeks storage at 45° C. are shown in the table below.

| | | FFA level after |
|---|---|---|
| | | 8 weeks at 45° C. |
| Example | pH of product | (wt % age) |
| 12 | 3.37 | 21.04 |
| N | 2.7 | 9.20 |
| O | 2.5 | 7.90 |
| P | 2.2 | 10.47 |

### Viscostability

Example 12 thickened unacceptably at 8 weeks

Example N thickened slightly less than Example 12

Example O had acceptable viscosity after 12 weeks

Example P thickened at 10 weeks and to an unacceptable level by 12 weeks

The results demonstrated that the formulation with the lowest degree of hydrolysis was most stable upon storage at 45° C.

The DSC data of the formulations is shown in the following Table.

| | | | | Temperature of | Temperature |
|---|---|---|---|---|---|
| | | Ratio | | the Principle | of minor |
| | Plasticizer | HT- | | DSC transition | DSC |
| Example | (P) | TEAQ:P | pH | peak (° C.) | transitions |
| 12 | Isofol 18E | 6:1 | 3.37 | 41.6 | — |
| P | Isofol 18E | 6:1 | 2.7 | 40.5 | — |
| O | Isofol 18E | 6:1 | 2.5 | 38.4 | — |
| N | Isofol 18E | 6:1 | 2.2 | 40.5 | 49.3 |

### EXAMPLE Q

The following example demonstrates the benefits can be obtained in concentrate formulations also. This HTTEAQ raw material for this example is the same as for Examples 5 to 8.

| | |
|---|---|
| HTTEAQ | 13.45% |
| Isofol 20 | 0.57% |
| Perfume | 0.95% |
| 1M HCl | 0.69% |
| Minors (Dye, perfume, preservative) | |
| 5% CaCl₂ soln | 0.3% |
| Water | to 100% |

The process of making this composition was
heat the water to 65° C.
add the HCl
add the minors and mix
premelt the HTTEAQ and the Isofol then add to the water with stirring
mix with recalculation
add half the CaCl₂
high shear mix for 1 batch volume with recirculation
begin cooling
high shear mix for 1 batch volume with recirculation whilst cooling
add perfume at 50° C.
cool to 30° C.
add remaining CaCl₂

After storage at 45° C. for 8 weeks, Free fatty acid (as a percentage of the total solids in the composition) was measured at 9.8%. Clearly, whilst there is a difference in total active levels in the composition (as compared to Example 3 which is a dilute example made using a HTTEAQ with a comparable residual amine level of the HTTEAQ), the benefits of this invention are obvious in that the FFA after 8 weeks at 45° C. is significantly lower (9.8% versus 27.78%).

This is also reflected in the fact that the product has good 45° C. storage stability of in excess of 12 weeks. Again, comparing it against the dilutes of Examples 5-8, these products are stable for >12 weeks at 45° C. (as opposed to ˜8 weeks for those dilutes based on fully hardened linear co-actives). Given that dilutes are usually more straightforward to make and more robust than concentrates, this demonstrates the advantage of the invention in terms of making stable concentrates with excellent hydrolytic stability.

### EXAMPLES R AND S

Further examples of the invention using the fabric softening active, HT DEEDMAC are given in the table below.

| | Example R | Example S |
|---|---|---|
| HT | 5.14 | |
| DEEDMAC | | |
| Isofol | 0.77 | — |
| 18E | | |
| Oleyl | — | 0.77 |
| alcohol | | |
| Perfume | 0.34 | 0.34 |
| Minors | Dye, antifoam, | Dye, antifoam, |
| | preservative | preservative |
| Water | To 100% | To 100% |
| 1 M HCl | Adjusted to pH 2.5 | Adjusted to pH |
| | | 2.5 |

HT DEEDMAC can be prepared by reacting 1 mol of methyldiethanolamine (MDEA) with about 2 mol of hard tallow fatty acid. The resultant amine is then quaternised using methyl chloride. The result is a 90% solids raw material (the remaining 10% being IPA).

We claim:

1. A fabric softening composition having a pH of from 2 to 3 and comprising
a) from 1.5 to 50% by weight of a cationic fabric softening compound having two or more alkyl or alkenyl chains each having an average chain length equal to, or greater than C₈ each connected to a nitrogen atom via at least one ester linkage, the iodine value of the parent fatty acyl compound or acid from which the alkyl or alkenyl chains are derived being from 0 to 20, the softening compound being free from acid amide links,
b) at least 0.15% by weight of perfume, and
c) a plasticizer which is liquid at ambient temperature, in an effective amount such that the fabric conditioning composition has a major phase transition peak of not more than 52° C. measured by differential scanning calorimetry (DSC).

2. A composition as claimed in claim 1 in which the weight ratio of fabric softening compound to plasticizer is in the range 3:1 to 50:1.

3. A composition as claimed in claim 2 in which the weight ratio of fabric softening compound to plasticizer is in the range 5:1 to 25:1.

4. A composition as claimed in claim 1 in which the fabric softening compound is selected from compounds of the formula: 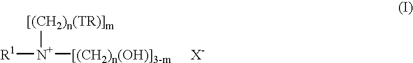
wherein each R is independently selected from a C₅₋₃₅ alkyl or alkenyl group; R¹ represents a C₁₋₄ alkyl, C₂₋₄ alkenyl or a C₁₋₄ hydroxyalkyl group; T is generally O—CO (i.e. an ester group bound to R via its carbon atom), but may alternatively be CO—O (i.e. an ester group bound to R via its oxygen atom); n is a number selected from 1 to 4; m is a number selected from 1, 2, or 3; and X⁻ is an anionic counter-ion, such as a halide or alkyl sulphate, e.g. chloride or methylsulphate.

5. A composition as claimed in claim 1 in which the fabric softening compound is selected from compounds of the formula: 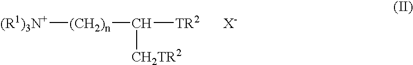
wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups; and wherein n, T, and X⁻ are as defined in claim 4.

6. A composition as claimed in claim 1 in which the fabric softening compound is selected from compounds of the formula:
(R¹)₂—N⁺—[(CH₂)ₙ—T—R²]₂X⁻ (III)
wherein each R¹ group is independently selected from C₁₋₄ alkyl, or C₂₋₄ alkenyl groups; and wherein each R² group is independently selected from C₈₋₂₈ alkyl or alkenyl groups; and n, T, and X⁻ are as defined in claim 4.

7. A composition as claimed in claim 1 in which the plasticizer is selected from unsaturated and/or branched alcohols and unsaturated and/or branched fatty acids.

8. A composition as claimed in claim 1 in which the plasticizer is selected from long chain fatty esters and asymmetric diols.

9. A composition as claimed in claim 7 in which the plasticizer is a branched alcohol having 12 to 18 carbon atoms.

10. A composition as claimed in claim 1 in which the composition has a major phase transition temperature below 50° C., preferably below 45° C.
